(19) United States
(12) Patent Application Publication
(10) Pub. No.: US 2015/0047396 A1
(43) Pub. Date: Feb. 19, 2015

(54) LAUNDRY TREATING APPLIANCE AND METHOD OF PREDICTING MECHANICAL DEGRADATION IN A LAUNDRY TREATING APPLIANCE

(71) Applicant: Whirlpool Corporation, Benton Harbor, MI (US)

(72) Inventors: HORACIO BECKERT POLLI, SAINT JOSEPH, MI (US); MICHAEL J. HAND, III, ANN ARBOR, MI (US); STEPHEN L. KERES, WATERVLIET, MI (US)

(73) Assignee: Whirlpool Corporation, Benton Harbor, MI (US)

(21) Appl. No.: 13/965,326

(22) Filed: Aug. 13, 2013

(51) Int. Cl. D06F 33/02; G01N 19/02

(52) U.S. Cl. CPC D06F 33/02; G01N 19/02
USPC 68/12.27; 73/9

(57) ABSTRACT

A laundry treating appliance having a rotatable container at least partially defining a treating chamber for receiving laundry for treatment according to an automatic cycle of operation and a motor rotationally driving the rotating chamber and a method of predicting mechanical degradation in a laundry treating appliance where the method includes rotating a rotatable container with a motor, monitoring over time a torque signal during the rotating, repeatedly determining over time a friction value from the torque signal, and predicting mechanical degradation based on a determined change in the friction value.

### BACKGROUND

Laundry treating appliances, such as clothes washers, refreshers, and non-aqueous systems, may have a configuration based on a rotating drum that defines a treating chamber in which laundry items are placed for treating according to one or more cycles of operation. The laundry treating appliance may have a controller that implements the cycles of operation having one or more operating parameters. The controller may control a motor to rotate the drum according to one of the cycles of operation. As the laundry treating appliance ages, it may be prone to wear and degradation in performance. Such degradation may lead to mechanical failure of the motor system and other systems.

### BRIEF SUMMARY

In one aspect, the invention relates to a method of predicting mechanical degradation in a laundry treating appliance, the method includes rotating a rotatable container with a motor, monitoring over time a torque signal during the rotating, repeatedly determining over time a friction value from the torque signal, determining a change in the friction value, and predicting mechanical degradation based on the determined change in the friction value.

In another aspect, the invention relates to a laundry treating appliance having a rotatable drum, a motor operably coupled with the rotatable drum and configured to rotatably drive the drum, and a controller configured to output the motor control signal to rotate the drum, monitor over time a torque signal for the motor during the rotating, repeatedly determine over time a friction value from a torque signal, determine over time a change in the friction value, and predict a mechanical degradation based on the determined change in the friction value.

### BRIEF DESCRIPTION OF THE DRAWINGS

In the drawings:

FIG. 1 is a schematic view of a laundry treating appliance in the form of a washing machine according to an embodiment of the invention.

FIG. 2 is a schematic of a control system of the laundry treating appliance of FIG. 1.

FIG. 3 is a flow chart illustrating a method of operating the laundry treating appliance according to an embodiment of the invention.

### DESCRIPTION OF EMBODIMENTS OF THE INVENTION

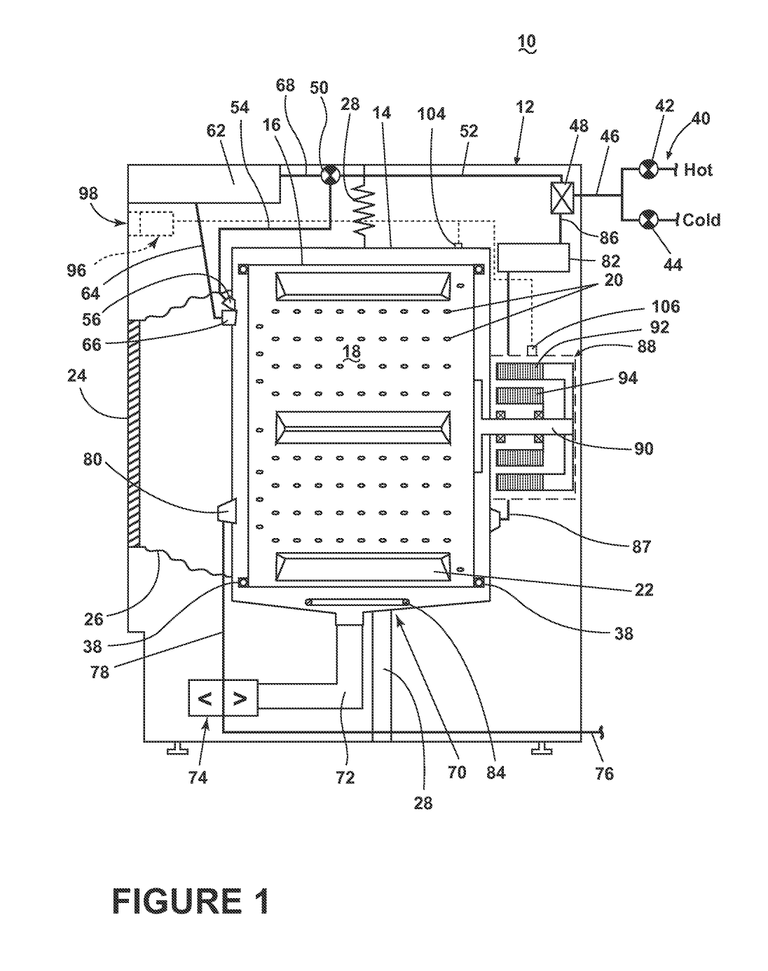

FIG. 1 is a schematic view of a laundry treating appliance according to an embodiment of the invention. The laundry treating appliance may be any appliance which performs a cycle of operation to clean or otherwise treat items placed in a container therein, non-limiting examples of which include a horizontal or vertical axis clothes washer; a combination washing machine and dryer; a dispensing dryer; a tumbling or stationary refreshing/revitalizing machine; an extractor; a non-aqueous washing apparatus; and a revitalizing machine.

As used herein, the term “vertical-axis” washing machine refers to a washing machine having a rotatable drum that rotates about a generally vertical axis relative to a surface that supports the washing machine. However, the rotational axis need not be perfectly vertical to the surface. The drum may rotate about an axis inclined relative to the vertical axis, with fifteen degrees of inclination being one example of the inclination. Similar to the vertical axis washing machine, the term “horizontal-axis” washing machine refers to a washing machine having a rotatable drum that rotates about a generally horizontal axis relative to a surface that supports the washing machine. The drum may rotate about the axis inclined relative to the horizontal axis, with fifteen degrees of inclination being one example of the inclination.

The laundry treating appliance of FIG. 1 is illustrated as a horizontal-axis washing machine 10, which may include a structural support system including a cabinet 12, which defines a housing within which a laundry holding system resides. The cabinet 12 may be a housing having a chassis and/or a frame, defining an interior enclosing components typically found in a conventional washing machine, such as motors, pumps, fluid lines, controls, sensors, transducers, and the like. Such components will not be described further herein except as necessary for a complete understanding of the invention.

The laundry holding system includes a tub 14 supported within the cabinet 12 by a suitable suspension system and a rotatable container or drum 16 provided within the tub 14, the drum 16 defines at least a portion of a laundry treating chamber 18 for receiving a laundry load for treatment. The drum 16 may include a plurality of perforations 20 such that liquid may flow between the tub 14 and the drum 16 through the perforations 20. A plurality of baffles 22 may be disposed on an inner surface of the drum 16 to lift the laundry load received in the treating chamber 18 while the drum 16 rotates. It may also be within the scope of the invention for the laundry holding system to include only a tub with the tub defining the laundry treating chamber.

The laundry holding system may further include a door 24 which may be movably mounted to the cabinet 12 to selectively close both the tub 14 and the drum 16. A bellows 26 may couple an open face of the tub 14 with the cabinet 12, with the door 24 sealing against the bellows 26 when the door 24 closes the tub 14.

The washing machine 10 may further include a suspension system 28 for dynamically suspending the laundry holding system within the structural support system.

The washing machine 10 may also include at least one balance ring 38 containing a balancing material moveable within the balance ring 38 to counterbalance an imbalance that may be caused by laundry in the treating chamber 18 during rotation of the drum 16. More specifically, the balance ring 38 may be coupled with the rotating drum 16 and configured to compensate for a dynamic imbalance during rotation of the rotatable drum 16. The balance ring 38 may extend circumferentially around a periphery of the drum 16 and may be located at any desired location along an axis of rotation of the drum 16. When multiple balance rings 38 are present, they may be equally spaced along the axis of rotation of the drum 16. For example, in the illustrated example a plurality of balance rings 38 are included in the washing machine 10 and the plurality of balance rings 38 are operably coupled with opposite ends of the rotatable drum 16.

The washing machine 10 may further include a liquid supply system for supplying water to the washing machine 10 for use in treating laundry during a cycle of operation. The liquid supply system may include a source of water, such as a household water supply 40, which may include separate valves 42 and 44 for controlling the flow of hot and cold water, respectively. Water may be supplied through an inlet conduit 46 directly to the tub 14 by controlling first and second diverter mechanisms 48 and 50, respectively. The diverter mechanisms 48, 50 may be a diverter valve having two outlets such that the diverter mechanisms 48, 50 may selectively direct a flow of liquid to one or both of two flow paths. Water from the household water supply 40 may flow through the inlet conduit 46 to the first diverter mechanism 48 which may direct the flow of liquid to a supply conduit 52. The second diverter mechanism 50 on the supply conduit 52 may direct the flow of liquid to a tub outlet conduit 54 which may be provided with a spray nozzle 56 configured to spray the flow of liquid into the tub 14. In this manner, water from the household water supply 40 may be supplied directly to the tub 14.

The washing machine 10 may also be provided with a dispensing system for dispensing treating chemistry to the treating chamber 18 for use in treating the laundry according to a cycle of operation. The dispensing system may include a dispenser 62 which may be a single use dispenser, a bulk dispenser or a combination of a single use and bulk dispenser.

Regardless of the type of dispenser used, the dispenser 62 may be configured to dispense a treating chemistry directly to the tub 14 or mixed with water from the liquid supply system through a dispensing outlet conduit 64. The dispensing outlet conduit 64 may include a dispensing nozzle 66 configured to dispense the treating chemistry into the tub 14 in a desired pattern and under a desired amount of pressure. For example, the dispensing nozzle 66 may be configured to dispense a flow or stream of treating chemistry into the tub 14 by gravity, i.e. a non-pressurized stream. Water may be supplied to the dispenser 62 from the supply conduit 52 by directing the diverter mechanism 50 to direct the flow of water to a dispensing supply conduit 68.

Non-limiting examples of treating chemistries that may be dispensed by the dispensing system during a cycle of operation include one or more of the following: water, enzymes, fragrances, stiffness/sizing agents, wrinkle releasers/reducers, softeners, antistatic or electrostatic agents, stain repellants, water repellants, energy reduction/extraction aids, antibacterial agents, medicinal agents, vitamins, moisturizers, shrinkage inhibitors, and color fidelity agents, and combinations thereof.

The washing machine 10 may also include a recirculation and drain system for recirculating liquid within the laundry holding system and draining liquid from the washing machine 10. Liquid supplied to the tub 14 through tub outlet conduit 54 and/or the dispensing supply conduit 68 typically enters a space between the tub 14 and the drum 16 and may flow by gravity to a sump 70 formed in part by a lower portion of the tub 14. The sump 70 may also be formed by a sump conduit 72 that may fluidly couple the lower portion of the tub 14 to a pump 74. The pump 74 may direct liquid to a drain conduit 76, which may drain the liquid from the washing machine 10, or to a recirculation conduit 78, which may terminate at a recirculation inlet 80. The recirculation inlet 80 may direct the liquid from the recirculation conduit 78 into the drum 16. The recirculation inlet 80 may introduce the liquid into the drum 16 in any suitable manner, such as by spraying, dripping, or providing a steady flow of liquid. In this manner, liquid provided to the tub 14, with or without treating chemistry may be recirculated into the treating chamber 18 for treating the laundry within.

The liquid supply and/or recirculation and drain system may be provided with a heating system which may include one or more devices for heating laundry and/or liquid supplied to the tub 14, such as a steam generator 82 and/or a sump heater 84. Liquid from the household water supply 40 may be provided to the steam generator 82 through the inlet conduit 46 by controlling the first diverter mechanism 48 to direct the flow of liquid to a steam supply conduit 86. Steam generated by the steam generator 82 may be supplied to the tub 14 through a steam outlet conduit 87. The steam generator 82 may be any suitable type of steam generator such as a flow through steam generator or a tank-type steam generator. Alternatively, the sump heater 84 may be used to generate steam in place of or in addition to the steam generator 82. In addition or alternatively to generating steam, the steam generator 82 and/or sump heater 84 may be used to heat the laundry and/or liquid within the tub 14 as part of a cycle of operation.

Additionally, the liquid supply and recirculation and drain system may differ from the configuration shown in FIG. 1, such as by inclusion of other valves, conduits, treating chemistry dispensers, sensors, such as water level sensors and temperature sensors, and the like, to control the flow of liquid through the washing machine 10 and for the introduction of more than one type of treating chemistry.

The washing machine 10 also includes a drive system for rotating the drum 16 within the tub 14. The drive system may include a motor 88 for rotationally driving the drum 16. The motor 88 may be directly coupled with the drum 16 through a drive shaft 90 to rotate the drum 16 about a rotational axis during a cycle of operation. The motor 88 may be a brushless permanent magnet (BPM) motor having a stator 92 and a rotor 94. Alternately, the motor 88 may be coupled with the drum 16 through a belt and a drive shaft to rotate the drum 16, as is known in the art. Other motors, such as an induction motor or a permanent split capacitor (PSC) motor, may also be used. The motor 88 may rotationally drive the drum 16 including that the motor 88 may rotate the drum 16 at various speeds in either rotational direction. The motor 88 may be configured to rotatably drive the drum 16 in response to a motor control signal.

The washing machine 10 also includes a control system for controlling the operation of the washing machine 10 to implement one or more cycles of operation. The control system may include a controller 96 located within the cabinet 12 and a user interface 98 that is operably coupled with the controller 96. The user interface 98 may include one or more knobs, dials, switches, displays, touch screens and the like for communicating with the user, such as to receive input and provide output. The user may enter different types of information including, without limitation, cycle selection and cycle parameters, such as cycle options.

The controller 96 may include the machine controller and any additional controllers provided for controlling any of the components of the washing machine 10. For example, the controller 96 may include the machine controller and a motor controller. Many known types of controllers may be used for the controller 96. The specific type of controller is not germane to the invention. It is contemplated that the controller may be a microprocessor-based controller that implements control software and sends/receives one or more electrical signals to/from each of the various working components to effect the control software. As an example, proportional control (P), proportional integral control (PI), and proportional derivative control (PD), or a combination thereof, a proportional integral derivative control (PID control), may be used to control the various components.

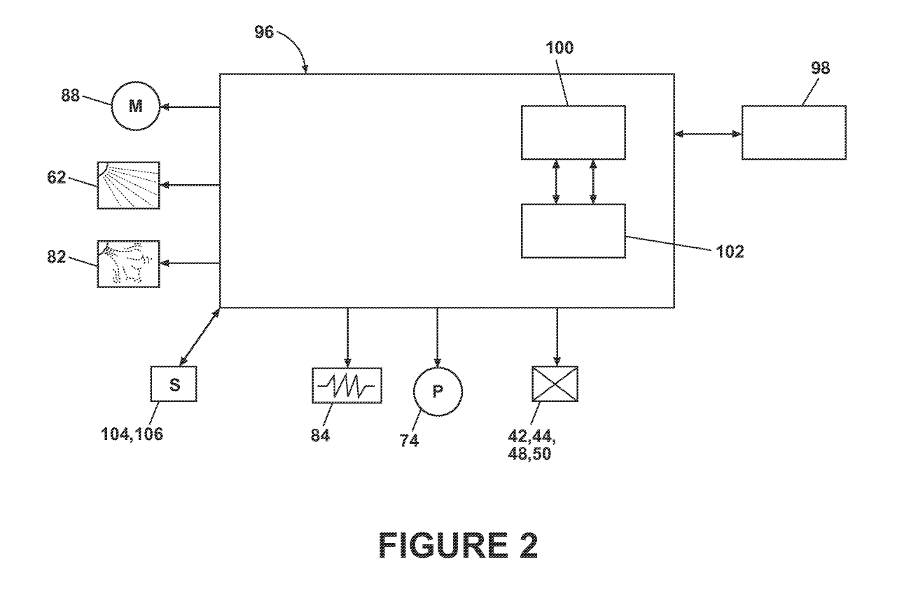

As illustrated in FIG. 2, the controller 96 may be provided with a memory 100 and a central processing unit (CPU) 102. The memory 100 may be used for storing the control software that may be executed by the CPU 102 in completing a cycle of operation using the washing machine 10 and any additional software. Examples, without limitation, of cycles of operation include: wash, heavy duty wash, delicate wash, quick wash, pre-wash, refresh, rinse only, and timed wash. The memory 100 may also be used to store information, such as a database or table, and to store data received from one or more components of the washing machine 10 that may be communicably coupled with the controller 96. The database or table may be used to store the various operating parameters for the one or more cycles of operation, including factory default values for the operating parameters and any adjustments to them by the control system or by user input.

The controller 96 may be operably coupled with one or more components of the washing machine 10 for communicating with and controlling the operation of the component to complete a cycle of operation. For example, the controller 96 may be operably coupled with the motor 88, the pump 74, the dispenser 62, the steam generator 82 and the sump heater 84 to control the operation of these and other components to implement one or more of the cycles of operation.

The controller 96 may also be coupled with one or more sensors 104 provided in one or more of the systems of the washing machine 10 to receive input from the sensors, which are known in the art and not shown for simplicity. Non-limiting examples of sensors 104 that may be communicably coupled with the controller 96 include: a treating chamber temperature sensor, a moisture sensor, a weight sensor, a chemical sensor, a position sensor, an acceleration sensor, a speed sensor, an orientation sensor, an imbalance sensor, a load size sensor, and a motor torque sensor, which may be used to determine a variety of system and laundry characteristics, such as laundry load inertia or mass and system imbalance magnitude and position.

In one example, a motor sensor such as a motor torque sensor 106 may also be included in the washing machine 10 and may provide a torque output or signal indicative of the torque applied by the motor 88. The motor torque may be a function of the inertia of the rotating drum 16 and the laundry load. The motor torque sensor 106 may also include a motor controller or similar data output on the motor 88 that provides data communication with the motor 88 and outputs motor characteristic information, generally in the form of an analog or digital signal, to the controller 96 that may be indicative of the applied torque. The controller 96 may use the motor characteristic information to determine the torque applied by the motor 88 using software that may be stored in the controller memory 100. Specifically, the motor torque sensor 106 may be any suitable sensor, such as a voltage or current sensor, for outputting a current or voltage signal indicative of the current or voltage supplied to the motor 88 to determine the torque applied by the motor 88. Additionally, the motor torque sensor 106 may be a physical sensor or may be integrated with the motor and combined with the capability of the controller 96, or may function as a sensor. For example, motor characteristics, such as speed, current, voltage, torque etc., may be processed such that the data provides information in the same manner as a separate physical sensor. In contemporary motors, the motors often have their own controller that outputs data for such information.

It has been determined that by monitoring the variation of parameters such as inertia and friction it may be possible to gauge the change in mechanical health of a laundry treating appliance such as the washing machine 10. During operation, the controller 96 may be configured to output a motor control signal to the motor 88 to rotate the drum 16. When the drum 16 with the laundry load rotates during an extraction phase, the distributed mass of the laundry load about the interior of the drum 16 is a part of the inertia of the rotating system of the drum 16 and laundry load, along with other rotating components of the laundry treating appliance. The total inertia and the friction within the system may be determined from the torque necessary to rotate the drum 16. Generally the motor torque for rotating the drum 16 with the laundry load may be represented in the following way:

τ=J*\dot{ω}+B*ω+C (1)

where, τ=torque, J=inertia, \dot{ω}=acceleration, ω=rotational speed, B=viscous damping coefficient, and C=coulomb friction.

Historically, to determine the inertia, it was necessary to have a plateau followed by a ramp. During the plateau, the rotational speed may be maintained to be constant, and the resulting acceleration (\dot{ω}) may be zero. Then, from equation (1), the torque may be expressed in terms of friction constants and omega in the following way:

τ=B*ω+C (2)

τ and ω are variables that may be readily determined from torque sensors and velocity sensors. The Bω+C may be easily calculated during a plateau as the DC torque at that plateau. This DC torque may be taken as the friction value at that speed. Once Bω+C is known, it is possible to determine the inertia by accelerating the drum 16 along a ramp. During such an acceleration, the inertia was the only unknown and could be solved for. The acceleration was normally defined by the ramp or sensed. For example, most ramps are accomplished by providing an acceleration rate to the motor. This acceleration rate may be used for the acceleration in the equation. It will be understood that friction tends to be a function of speed and may increase as speed increases.

Alternatively, the friction value may be determined by dwelling at two different speed plateaus. Then the B and C terms can be solved independently by combining the DC torque and speed information from the two plateaus. In such an instance, the equation again reduces to:

τᵢ=B*ωᵢ+C (3)

where B and C can be solved by combining the equations for i=1,2. Then B, C, or Bω+C may be taken as the friction value. It will be understood that more than two dwell speeds may be used to improve the friction calculation. In such a case, linear regression may be used to calculate the B and C terms from the i>2 equations.

Alternatively, the friction value may be determined with or without dwelling at a constant speed by utilizing a parameter estimator. In such an embodiment, a mathematical model of the washer is used to decompose the torque into contributions from acceleration, friction, and unbalance. A widely-known algorithm such as recursive least squares may be used to estimate the parameters in such a model. One or more parameters in such a model pertain to the contribution to torque from friction. Any combination of these parameters may be taken as the friction value.

The controller 96 may monitor over time a torque signal for the motor 88 during the rotation of the drum 16. The controller 96 may also repeatedly determine over time a friction value from a torque signal and determine over time a change in the friction value. This may include that the controller 96 may be configured to determine a friction value several times during a cycle of operation and for multiple cycles of operation and store such information for further analysis. From the determined change in the friction value the controller 96 may predict a mechanical degradation of the washing machine 10.

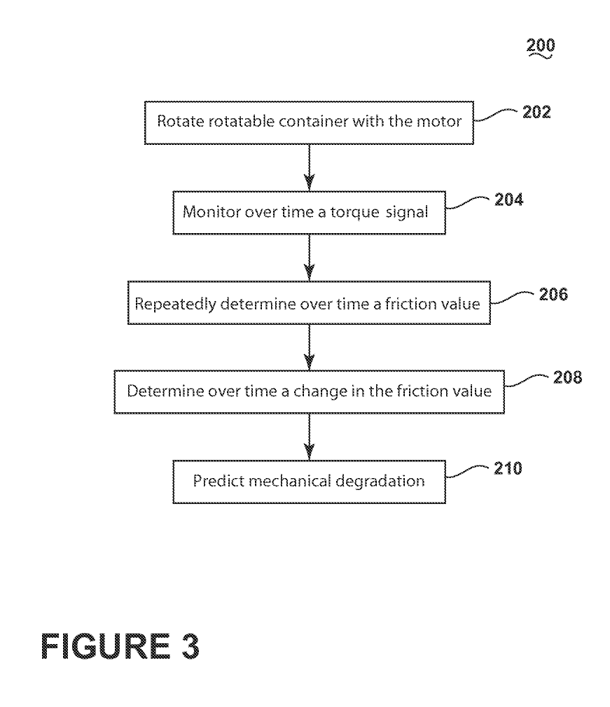

Referring now to FIG. 3, a flow chart of a method 200 for operating a laundry treating appliance, such as the washing machine 10, is illustrated. The sequence of steps depicted for this method is for illustrative purposes only, and is not meant to limit the method in any way as it is understood that the steps may proceed in a different logical order or additional or intervening steps may be included without detracting from the invention. The method 200 may be implemented in any suitable manner, such as automatically or manually, as a stand-alone phase or cycle of operation or as a phase of an operation cycle of the washing machine 10.

At 202, the controller 96 may rotate the drum 16 through operation of the motor 88. This may be done as part of an execution of the automatic cycle of operation. The drum 16 may be rotated at any suitable rotational speed where the viscous damping coefficient and/or Coulomb friction may be determined. This may include that the speed of the drum 16 may be ramped up and/or that the drum 16 may be rotated at a predetermined rotational speed or within a range of predetermined speeds. For example, the speed of the drum 16 may be ramped such that the drum 16 may be rotated by the motor 88 from a non-satellizing speed to a satellizing speed. It is contemplated that the satellizing speed may be a predetermined speed or may be a speed at which the controller 96 determines the laundry may be satellized.

While the drum 16 is being rotated, a torque signal for the motor 88 may be monitored over time as indicated at 204. For example, the controller 96 may receive a signal from the motor torque sensor 106 while the drum 16 is being rotated. From the torque signal the controller 96 may repeatedly determine over time a friction value such as at 206. This may include determining a value indicative of the viscous friction, the Coulomb friction, or a combination of the viscous and Coulomb friction.

It is contemplated that the rotating at 202, the monitoring over time a torque signal at 204, and the repeatedly determining over time a friction value at 206 may be done during one or more cycles of operation by the controller 96 implementing an algorithm or executable set of instructions stored in the memory 100. More specifically, the torque single may be monitoring over at least one cycle of operation including that the torque signal may be monitored over multiple cycles of operation. The repeatedly determining over time the friction value at 206 may include determining a friction value multiple times during a cycle of operation and/or determining a friction value for multiple cycles of operation. For example, it is contemplated that the friction value may be determined at multiple predetermined speeds during a single cycle, at one predetermined rotational speed during a single cycle, at a same predetermined rotational speed for multiple cycles of operation, etc. By way of further example, the friction value may be determined at a same phase of the cycle of operation for the multiple cycles of operation. For example, the friction value may be determined during the spin or extraction phase of each of the multiple cycles of operation.

Regardless of whether the friction value may be determine multiple times during a single cycle of operation or during multiple cycles of operation a change in the friction value over time may be determined at 208. For example, determining the change in the friction value may include determining a difference in a subsequent friction value as compared to a prior friction value.

At 210, mechanical degradation of the laundry treating appliance may be predicted based on the determined change in the friction. By way of non-limiting example, predicting the mechanical degradation may include comparing the determined change to a change threshold. In this manner, the controller 96 may determine if the determined change is acceptable. The term “satisfies” the threshold is used herein to mean that the determined change satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted. In implementation, the change threshold and comparisons may be converted to an algorithm to predict mechanical degradation of the laundry treating appliance. Such an algorithm may be converted to a computer program including a set of executable instructions, which may be executed by the controller 96.

It will be understood that the method may be flexible and that the method 200 illustrated is merely for illustrative purposes. For example, it is contemplated that the controller 96 may continue to determine over time a change in the friction value until the change in the friction value is determined to be unacceptable or indicative of mechanical degradation. Further, while portions of the method and description thus far have been specific to a washing machine it will be understood that embodiments of the invention may be utilized with any suitable laundry treating appliance. Further, it is also contemplated that the change in the friction value may be determined when it has been determined that the load size within the laundry treating appliance is the same. In this manner, the controller 96 may initially determine a size of the laundry load and then determine a friction value only if the determined load size is that of a predetermined or preselected load size. This may ensure consistency between friction determinations.

It is also contemplated that once the friction value has been determined, such as at 206 that the controller 96 may compare the determined friction value to a threshold friction value and that the mechanical degradation of the laundry treating appliance may be predicted based thereon. Further still, both the change in the friction value as determined at 208 and an absolute friction value as determined at 206 may be used in combination to predict mechanical degradation of the laundry treating appliance. In implementation, the threshold friction value and/or the change threshold and comparisons may be converted to an algorithm or computer program, which may be executed by the controller 96, to predict mechanical degradation of the laundry treating appliance.

Further, once mechanical degradation of the laundry treating appliance is predicted the laundry treating appliance may be operated in a variety of manners in response to the predicted mechanical degradation including that one or more parameters of the automatic cycle of operation may be adjusted in response to the level of degradation. This may include by way of non-limiting examples reducing the maximum spin speeds reached, reducing tumbling speeds or reducing tumbling duration. Furthermore, the controller 96 may provide an indication on the user interface 98 to alert the consumer that mechanical degradation has been predicted or simply that service should be contacted. Further still, if the laundry treating appliance includes WiFi or other communication capabilities the controller 96 may provide an indication to a service department that mechanical degradation has been predicted.

The above described embodiments provided a variety of benefits including that the above described laundry treating appliance and method may be used to predict mechanical degradation of the laundry treating appliance such that an upcoming need for maintenance may be determined. Current mechanical degradation and failure detection algorithms may only detect these failures after they have happened. For example, customers may detect failures and degradation in performance from the noise produced by the laundry treating appliance and upon noticing these failures customers then call for maintenance and must wait for service. The above embodiments allow accurate predictions to be made and by predicting such problems sufficient time may be allowed to make repairs before such failures and degradation occur, which allows for improved customer satisfaction.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A method of predicting mechanical degradation in a laundry treating appliance having a rotatable container at least partially defining a treating chamber for receiving laundry for treatment according to an automatic cycle of operation, and a motor rotationally driving the rotating chamber, the method comprising:
rotate the rotatable container with the motor;
monitor over time a torque signal for the motor during the rotating;
repeatedly determine over time a friction value from the torque signal;
determine over time a change in the friction value; and
predict mechanical degradation based on the determined change in the friction value.

2. The method of claim 1 wherein the rotating the rotatable container is done as part of an execution of the automatic cycle of operation.

3. The method of claim 2 wherein the repeatedly determining over time the friction value comprises at least one of: determining a friction value multiple times during a cycle of operation or determining a friction value for multiple cycles of operation.

4. The method of claim 3 wherein the friction value is determined at a predetermined rotational speed.

5. The method of claim 4 wherein the friction value is determined at a same predetermined rotational speed for multiple cycles of operation.

6. The method of claim 5 wherein the friction value is determined at a same phase of the cycle of operation for the multiple cycles of operation.

7. The method of claim 6 wherein the same phase comprises an extraction phase.

8. The method of claim 1 wherein the monitoring over time the torque single comprises monitoring over at least one cycle of operation.

9. The method of claim 8 wherein the monitoring over at least one cycle of operation comprises monitoring over multiple cycles of operation.

10. The method of claim 1 wherein the repeatedly determining over time the friction value comprises at least one of: determining a friction value multiple times during a cycle of operation or determining a friction value for multiple cycles of operation.

11. The method of claim 10 wherein the friction value is determined at a predetermined rotational speed.

12. The method of claim 11 wherein the friction value is determined at a same predetermined rotational speed for multiple cycles of operation.

13. The method of claim 1 wherein the repeatedly determining over time the friction value comprises determining a value indicative of at least one of: a viscous friction, Coulomb friction, or a combination of viscous and Coulomb friction.

14. The method of claim 1 wherein the determining the change in the friction value comprises determining a difference in a subsequent friction value to a prior friction value.

15. The method of claim 1 wherein predicting the mechanical degradation comprises comparing the determined change to a change threshold.

16. The method of claim 1 wherein the monitoring, determining, and predicting are implemented by a controller of the laundry treating appliance.

17. A laundry treating appliance, comprising:
a rotatable drum at least partially defining a treating chamber in which a laundry load is received for treatment;
a motor operably coupled with the rotatable drum and configured to rotatably drive the drum in response to a motor control signal; and
a controller configured to output the motor control signal to rotate the drum, monitor over time a torque signal for the motor during the rotating, repeatedly determine over time a friction value from a torque signal, determine over time a change in the friction value, and predict a mechanical degradation based on the determined change in the friction value.

18. The laundry treating appliance of claim 17, further comprising a torque sensor that outputs a signal indicative of the torque of the motor.

19. The laundry treating appliance of claim 17 wherein the controller being configured to repeatedly determine over time the friction value comprises the controller being configured to determine a friction value for multiple cycles of operation.

20. The laundry treating appliance of claim 17 wherein the controller is configured to adjust one or more parameters of the cycle of operation based on the predicted mechanical degradation or provide an indication that mechanical degradation has been predicted.
